(19) United States
(12) Patent Application Publication
(10) Pub. No.: US 2022/0188902 A1
(43) Pub. Date: Jun. 16, 2022

(54) OPTIMIZED GROUP BUYING SCHEMES

(71) Applicant: International Business Machines Corporation, Armonk, NY (US)

(72) Inventors: Radu Marinescu, Dublin (IE); Akihiro Kishimoto, Setagaya (JP)

(21) Appl. No.: 17/120,320

(22) Filed: Dec. 14, 2020

(51) Int. Cl. G06Q 30/06

(52) U.S. Cl. CPC G06Q 30/0633; G06Q 30/0605; G06Q 30/0641; G06Q 30/0625; G06Q 30/0617

(57) ABSTRACT

In an approach for generating and recommending optimized shopping orders for a group of users that collectively purchase bundles of goods, a processor generates an initial shopping order for each user in a group of shopping users, based on one or more preferences and constraints of each user on one or more items to buy from a stock. A processor optimizes the initial shopping order for each user based on one or more objectives of each user. A processor outputs the optimized shopping order for each user.

### BACKGROUND

The present disclosure relates generally to the field of group shopping, and more particularly to generating and recommending optimized shopping orders for a group of users that collectively purchase bundles of goods.

Online shopping is a form of electronic commerce which allows consumers to directly buy goods or services from a seller over the Internet using a web browser or a mobile app. Consumers may find a product of interest by visiting the website of the retailer directly or by searching among alternative vendors using a shopping search engine, which displays the same product's availability and pricing at different e-retailers. An online shop evokes the physical analogy of buying products or services at a regular “brick-and-mortar” retailer or shopping center. The process is called business-to-consumer online shopping. When an online store is set up to enable businesses to buy from another business, the process is called business-to-business online shopping. A typical online store may enable a customer to browse the firm's range of products and services, view photos or images of the products, along with information about the product specifications, features and prices. Online stores usually enable shoppers to use “search” features to find specific models, brands or items. Group buying, also known as collective buying, offers products and services at significantly reduced prices on the condition that a minimum number of buyers would make the purchase. In recent times, group buying websites have emerged in the online shopping business. Typically, these websites may feature a deal of the day, with the deal kicking in when a set number of people agree to buy the product or service. Many of the group-buying sites work by negotiating deals with local merchants and promising to deliver a higher foot count in exchange for better prices.

### SUMMARY

Aspects of an embodiment of the present disclosure disclose an approach for generating and recommending optimized shopping orders for a group of users that collectively purchase bundles of goods. A processor generates an initial shopping order for each user in a group of shopping users, based on one or more preferences and constraints of each user on one or more items to buy from a stock. A processor optimizes the initial shopping order for each user based on one or more objectives of each user. A processor outputs the optimized shopping order for each user.

### BRIEF DESCRIPTION OF THE DRAWINGS

FIG. 1 is a functional block diagram illustrating a group shopping optimization environment, in accordance with an embodiment of the present disclosure.

FIG. 2 is a flowchart depicting operational steps of a group shopping optimization module within a computing device of FIG. 1, in accordance with an embodiment of the present disclosure.

FIG. 3 illustrates an exemplary functional diagram of the group shopping optimization module within the computing device of FIG. 1, in accordance with an embodiment of the present disclosure.

FIG. 4 is a block diagram of components of the computing device of FIG. 1, in accordance with an embodiment of the present disclosure.

### DETAILED DESCRIPTION

The present disclosure is directed to systems and methods for generating and recommending optimized shopping orders for a group of users that collectively purchase bundles of goods.

Embodiments of the present disclosure recognize a need for optimizing shopping orders in order to, for example, minimize cost, maximize number of products on order, minimize waste, and maximize discounts. When a group of people want to buy various products in bulk, individuals may have their own preferences and constraints with respect to brands and/or quantity of products. Embodiments of the present disclosure disclose automatically recommending for each member of the group a shopping order that satisfies the member's preferences and constraints and at the same time optimizes the objectives of the member. Embodiments of the present disclosure discloses automatically splitting goods in shopping orders between group members. Embodiments of the present disclosure disclose automatically connecting to a supplier's database to access current available stocks. Embodiments of the present disclosure disclose providing a user interface for a user to select a preferred shopping order and modify the shopping order by, e.g., adding and/or removing items and changing quantities of existing items. Embodiments of the present disclosure disclose taking into consideration the modifications coming from the users and recomputing the optimized shopping orders for the users. Embodiments of the present disclosure disclose learning users' preferences over time and using the preferences in the future for recommending a shopping order based on the learned preferences from the user.

Embodiments of the present disclosure disclose automatically generating shopping lists to a group of people that buy in bulk certain kinds of goods. Furthermore, the lists may satisfy the users preferences and constraints and may be optimized with respect to one or more objectives. The users can also revise the recommended lists in an interactive manner, while the system ensures that all user constraints and preferences are satisfied, and objectives are optimized. Embodiments of the present disclosure disclose taking as input the preferences and constraints of a set of users, a snapshot of current stocks from a plurality of suppliers and an objective function. Embodiments of the present disclosure disclose producing as output a set of optimized shopping orders, one for each user, that optimize the objective function and satisfy the user preferences and constraints. Embodiments of the present disclosure disclose that the objective function can include the cost of the order, an estimate of the waste compared with previous orders, the number of products in the order, cumulative discount associated with one or more products in the order. Embodiments of the present disclosure disclose an interactive module that allows the users to revise their orders in an interactive manner. Embodiments of the present disclosure disclose an optimization module that allows each user to specify the user's own objective which can be conflicting to each other. Embodiments of the present disclosure disclose learning and updating additional preferences and constraints for each user from the optimized shopping orders generated over time.

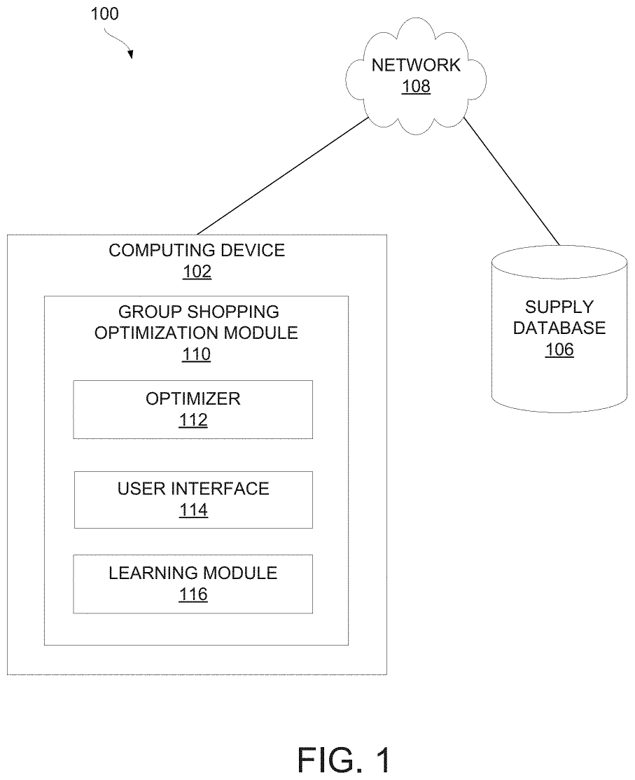

The present disclosure will now be described in detail with reference to the Figures. FIG. 1 is a functional block diagram illustrating a group shopping optimization environment, generally designated 100, in accordance with an embodiment of the present disclosure.

In the depicted embodiment, group shopping optimization environment 100 includes computing device 102, supply database 106, and network 108. In the depicted embodiment, supply database 106 is located externally and accessed through a communication network such as network 108. In some embodiments, supply database 106 may be accessed directly by computing device 102. In some embodiments, supply database 106 may be located on computing device 102. In one or more embodiments, supply database 106 is configured to store data and information of stocks available for users to buy.

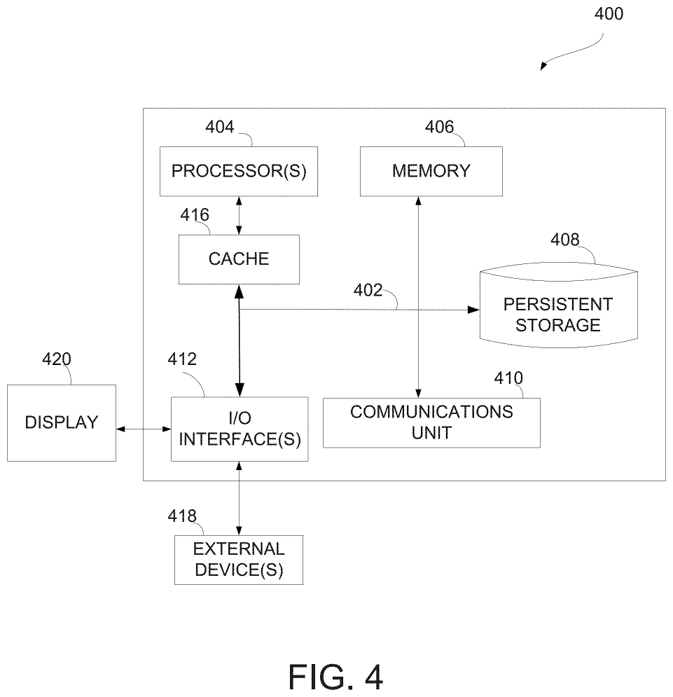

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to group shopping optimization module 110 and network 108 and is capable of processing program instructions and executing group shopping optimization module 110, in accordance with an embodiment of the present disclosure. Computing device 102 may include internal and external hardware components, as depicted and described in further detail with respect to FIG. 4.

Further, in the depicted embodiment, computing device 102 includes group shopping optimization module 110. In the depicted embodiment, group shopping optimization module 110 is located on computing device 102. However, in other embodiments, group shopping optimization module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and group shopping optimization module 110, in accordance with a desired embodiment of the disclosure.

In one or more embodiments, group shopping optimization module 110 is configured to generate an initial shopping order for each user in a group of shopping users, based on preferences and constraints of each user on items to buy from a stock, e.g., based on supply database 106. Supply database 106 may store data and information of stocks available for users to buy. The group of shopping users may want to buy various items or products in bulk. In an example, each user may have the user's own preferences and constraints with respect to brands, quantity of products, and other aspects. For example, some users may prefer to a preferred brand. Some users may have a constraint regarding the quantity of a product or a specific brand, e.g., at least the quantity must be 5 kg but less than 10 kg of rice and or the brand of a product must be brand X. In an example, group shopping optimization module 110 may access information and data of the current supplier stocks from supply database 106. For each user in the group of shopping users, group shopping optimization module 110 may select items available in supply database 106 based on the preferences of the user. In an example, group shopping optimization module 110 may add a product to the order such that the product is in user's preferences. Group shopping optimization module 110 may select items available in supply database 106 that satisfy the constraints of the user. In an example, for each added product, group shopping optimization module 110 may select a quantity that satisfies the user's constraints. Group shopping optimization module 110 may detect that a certain product in the user's preferences may be out of stock. Group shopping optimization module 110 may decide not to pick the certain product for the user. Group shopping optimization module 110 may determine that all preferences and constraints of the user are satisfied for the user. Group shopping optimization module 110 may repeatedly select items available in supply database 106 that satisfy the user's preferences and constraints for each user in the group of shopping users. Group shopping optimization module 110 may update the stocks in supply database 106 to reflect the changes to the current shopping orders.

In one or more embodiments, group shopping optimization module 110 is configured to optimize the initial shopping order for each user based on one or more objectives of each user. Each user may have various objectives to optimize: for example, to minimize a cost, maximize number of products on order, minimize waste, and/or maximize discounts. In some examples, objectives can be conflicting (e.g., some users want to minimize cost, but others may want to maximize the size of an order). Some products can be split amongst individuals, but some other products cannot be split. In an example, group shopping optimization module 110 may randomly and repeatedly adjust a small quantity of an item in the initial shopping order for each user. Group shopping optimization module 110 may satisfy the preferences and constraints of each user in each adjustment of the small quantity of the item for each user. Group shopping optimization module 110 may repeatedly update the initial shopping order based on improvement of the one or more objectives of each user. Group shopping optimization module 110 may dynamically update the stocks in supply database 106 to reflect a change to the initial shopping order of each user for the group of users. Group shopping optimization module 110 may resolve conflicts of objectives between multiple users in the group of users. In an example, group shopping optimization module 110 may receive as input the initial shopping orders, constraints, current stocks, and an objective function of each user. For each shopping order, group shopping optimization module 110 may repeat until an objective value of the objective function of each user cannot be improved anymore. For example, for each item or product in the shopping order for each user, group shopping optimization module 110 may randomly adjust the product's (“p”) quantity with +e or −e, where e is a small number. If p′=p+e, group shopping optimization module 110 may update stock value “S” with S=S−e for the product p. If p′=p−e, group shopping optimization module 110 may update stock value S with S=S+e for the product p. If there is not enough stock for p, group shopping optimization module 110 may select one or more orders and transfer p to the current order without violating any other preferences and constraints. Group shopping optimization module 110 may update the objective function for each user and keep modification so that the objective function may become better. Group shopping optimization module 110 may return new optimized orders for each user.

In one or more embodiments, group shopping optimization module 110 is configured to interactively update a shopping order based on an interactive input from a user. For example, group shopping optimization module 110 may provide user interface 114 for a user to select the shopping order and modify the shopping order, e.g., by adding or removing items, and or changing quantities of existing items. Group shopping optimization module 110 may take into consideration the modifications coming from the user and may recompute and generate an optimized shopping order for the user based on the user's modification. Group shopping optimization module 110 may perform the recomputing in an interactive manner with the user.

In one or more embodiments, group shopping optimization module 110 is configured to output an optimized shopping order for each user. Group shopping optimization module 110 may recommend an optimized shopping order for each user in a group of shopping users. Group shopping optimization module 110 may automatically recommend for each user of the shopping group a shopping order that satisfies the user's preferences and constraints and at the same time optimize the objectives for each user. Group shopping optimization module 110 may automatically split goods between group members to optimize the objectives for each user.

In one or more embodiments, group shopping optimization module 110 is configured to learn additional preferences and constraints for each user from the optimized shopping orders over time. Group shopping optimization module 110 may learn users' preferences over time and may use the preferences in the future for recommending optimized shopping orders. In an example, group shopping optimization module 110 may analyze the history of shopping orders and preferences and constraints of a user. Group shopping optimization module 110 may update the preferences and constraints for the user. For example, group shopping optimization module 110 may extract the historical shopping orders of the user. For each item in the historical shopping orders, group shopping optimization module 110 may extract minimum and maximum quantities ordered and may add a quantity constraint between the minimum and maximum quantities. For each item in the historical shopping orders, group shopping optimization module 110 may extract the most common brand of the item and may add a preference, e.g., the most common brand, to the preferences of the user.

In the depicted embodiment, group shopping optimization module 110 includes optimizer 112, user interface 114 and learning module 116. In one or more embodiments, optimizer 112 is configured to generate an initial shopping order for each user in a group of shopping users, based on preferences and constraints of each user on items to buy from a stock, e.g., based on supply database 106. Supply database 106 may store data and information of stocks available for users to buy. The group of shopping users may want to buy various items or products in bulk. In an example, each user may have the user's own preferences and constraints with respect to brands, quantity of products, and other aspects. For example, some users may prefer to a preferred brand. Some users may have a constraint regarding the quantity of a product or a specific brand, e.g., at least the quantity must be 5 kg but less than 10 kg of rice and or the brand of a product must be brand X. In an example, optimizer 112 may access information and data of the current supplier stocks from supply database 106. For each user in the group of shopping users, optimizer 112 may select items available in supply database 106 based on the preferences of the user. In an example, optimizer 112 may add a product to the order such that the product is in user's preferences. Optimizer 112 may select items available in supply database 106 that satisfy the constraints of the user. In an example, for each added product, optimizer 112 may select a quantity that satisfies the user's constraints. Optimizer 112 may detect that a certain product in the user's preferences may be out of stock. Optimizer 112 may decide not to pick the certain product for the user. Optimizer 112 may determine that all preferences and constraints of the user are satisfied for the user. Optimizer 112 may repeatedly select items available in supply database 106 that satisfy the user's preferences and constraints for each user in the group of shopping users. Optimizer 112 may update the stocks in supply database 106 to reflect the changes to the current shopping orders.

In one or more embodiments, optimizer 112 is configured to optimize the initial shopping order for each user based on one or more objectives of each user. Each user may have various objectives to optimize: for example, to minimize a cost, maximize number of products on order, minimize waste, and or maximize discounts. In some examples, objectives can be conflicting (e.g., some users want to minimize cost, but others may want to maximize the size of an order). Some products can be split amongst individuals, but some other products cannot be split. In an example, optimizer 112 may randomly and repeatedly adjust a small quantity of an item in the initial shopping order for each user. Optimizer 112 may satisfy the preferences and constraints of each user in each adjustment of the small quantity of the item for each user. Optimizer 112 may repeatedly update the initial shopping order based on improvement of the one or more objectives of each user. Optimizer 112 may dynamically update the stocks in supply database 106 to reflect a change to the initial shopping order of each user for the group of users. Optimizer 112 may resolve conflicts of objectives between multiple users in the group of users. In an example, optimizer 112 may receive as input the initial shopping orders, constraints, current stocks, and an objective function of each user. For each shopping order, optimizer 112 may repeat until an objective value of the objective function of each user cannot be improved anymore. For example, for each item or product in the shopping order for each user, optimizer 112 may randomly adjust the product's (“p”) quantity with +e or −e, where e is a small number. If p′=p+e, optimizer 112 may update stock value “S” with S=S−e for the product p. If p′=p−e, group shopping optimization module 110 may update stock value S with S=S+e for the product p. If there is not enough stock for p, optimizer 112 may select one or more orders and transfer p to the current order without violating any other preferences and constraints. Optimizer 112 may update the objective function for each user and keep modification so that the objective function may become better. Optimizer 112 may return new optimized orders for each user.

In one or more embodiments, user interface 114 is configured to provide an interface for a user to interactively update a shopping order. For example, user interface 114 may provide an interface for a user to select the shopping order and modify the shopping order, e.g., by adding or removing items, and or changing quantities of existing items. User interface 114 may receive the modifications coming from the user and may recompute and generate an optimized shopping order for the user based on the user's modification. Group shopping optimization module 110 may perform the recomputing based on the user's modification through user interface 114 in an interactive manner with the user.

In one or more embodiments, learning module 116 is configured to learn additional preferences and constraints for each user from the optimized shopping orders over time. Learning module 116 may learn users' preferences over time and may use the preferences in the future for recommending optimized shopping orders. In an example, learning module 116 may analyze the history of shopping orders and preferences and constraints of a user. Learning module 116 may update the preferences and constraints for the user. For example, group shopping optimization module 110 may extract the historical shopping orders of the user. For each item in the historical shopping orders, learning module 116 may extract minimum and maximum quantities ordered and may add a quantity constraint between the minimum and maximum quantities. For each item in the historical shopping orders, learning module 116 may extract the most common brand of the item and may add a preference, e.g., the most common brand, to the preferences of the user.

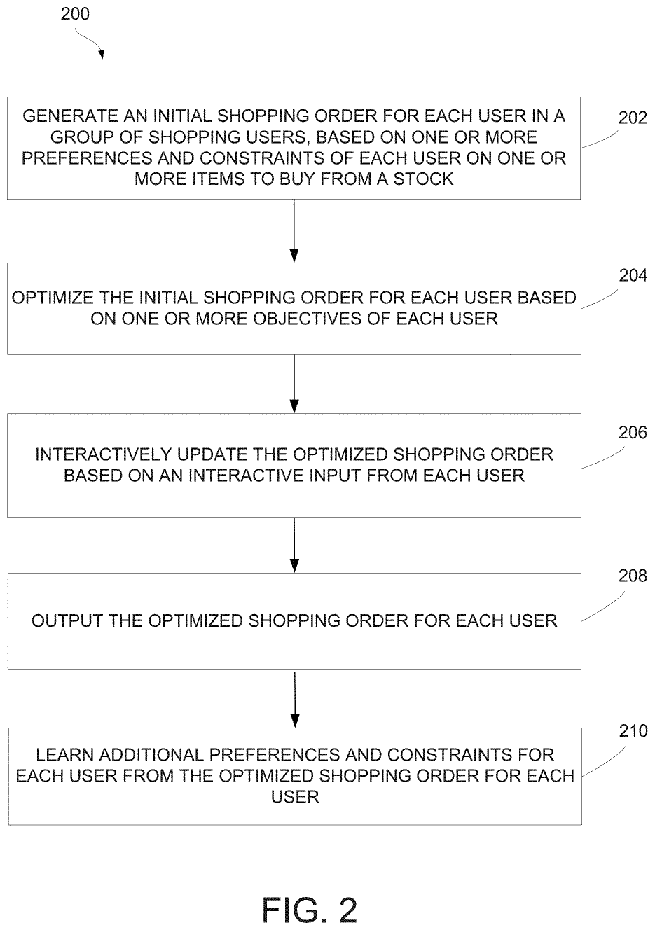

FIG. 2 is a flowchart 200 depicting operational steps of group shopping optimization module 110 in accordance with an embodiment of the present disclosure.

Group shopping optimization module 110 operates to generate an initial shopping order for each user in a group of shopping users, based on preferences and constraints of each user on items to buy from a stock, e.g., based on supply database 106. Group shopping optimization module 110 also operates to optimize the initial shopping order for each user based on one or more objectives of each user. Group shopping optimization module 110 operates to interactively update a shopping order based on an interactive input from a user. Group shopping optimization module 110 operates to output the optimized shopping order for each user. Group shopping optimization module 110 operates to learn additional preferences and constraints for each user from the optimized shopping orders over time.

In step 202, group shopping optimization module 110 generates an initial shopping order for each user in a group of shopping users, based on preferences and constraints of each user on items to buy from a stock, e.g., based on supply database 106. Supply database 106 may store data and information of stocks available for users to buy. The group of shopping users may want to buy various items or products in bulk. In an example, each user may have the user's own preferences and constraints with respect to brands, quantity of products, and other aspects. For example, some users may prefer to a preferred brand. Some users may have a constraint regarding the quantity of a product or a specific brand, e.g., at least the quantity must be 5 kg but less than 10 kg of rice and or the brand of a product must be brand X. In an example, group shopping optimization module 110 may access information and data of the current supplier stocks from supply database 106. For each user in the group of shopping users, group shopping optimization module 110 may select items available in supply database 106 based on the preferences of the user. In an example, group shopping optimization module 110 may add a product to the order such that the product is in user's preferences. Group shopping optimization module 110 may select items available in supply database 106 that satisfy the constraints of the user. In an example, for each added product, group shopping optimization module 110 may select a quantity that satisfies the user's constraints. Group shopping optimization module 110 may detect that a certain product in the user's preferences may be out of stock. Group shopping optimization module 110 may decide not to pick the certain product for the user. Group shopping optimization module 110 may determine that all preferences and constraints of the user are satisfied for the user. Group shopping optimization module 110 may repeatedly select items available in supply database 106 that satisfy the user's preferences and constraints for each user in the group of shopping users. Group shopping optimization module 110 may update the stocks in supply database 106 to reflect the changes to the current shopping orders.

In step 204, group shopping optimization module 110 optimizes the initial shopping order for each user based on one or more objectives of each user. Each user may have various objectives to optimize: for example, to minimize a cost, maximize number of products on order, minimize waste, and or maximize discounts. In some examples, objectives can be conflicting (e.g., some users want to minimize cost, but others may want to maximize the size of an order). Some products can be split amongst individuals, but some other products cannot be split. In an example, group shopping optimization module 110 may randomly and repeatedly adjust a small quantity of an item in the initial shopping order for each user. Group shopping optimization module 110 may satisfy the preferences and constraints of each user in each adjustment of the small quantity of the item for each user. Group shopping optimization module 110 may repeatedly update the initial shopping order based on improvement of the one or more objectives of each user. Group shopping optimization module 110 may dynamically update the stocks in supply database 106 to reflect a change to the initial shopping order of each user for the group of users. Group shopping optimization module 110 may resolve conflicts of objectives between multiple users in the group of users. In an example, group shopping optimization module 110 may receive as input the initial shopping orders, constraints, current stocks, and an objective function of each user. For each shopping order, group shopping optimization module 110 may repeat until an objective value of the objective function of each user cannot be improved anymore. For example, for each item or product in the shopping order for each user, group shopping optimization module 110 may randomly adjust the product's (“p”) quantity with +e or −e, where e is a small number. If p′=p+e, group shopping optimization module 110 may update stock value “S” with S=S−e for the product p. If p′=p−e, group shopping optimization module 110 may update stock value S with S=S+e for the product p. If there is not enough stock for p, group shopping optimization module 110 may select one or more orders and transfer p to the current order without violating any other preferences and constraints. Group shopping optimization module 110 may update the objective function for each user and keep modification so that the objective function may become better. Group shopping optimization module 110 may return new optimized orders for each user.

In step 206, group shopping optimization module 110 interactively updates a shopping order based on an interactive input from a user. For example, group shopping optimization module 110 may provide user interface 114 for a user to select the shopping order and modify the shopping order, e.g., by adding or removing items, and or changing quantities of existing items. Group shopping optimization module 110 may take into consideration the modifications coming from the user and may recompute and generate an optimized shopping order for the user based on the user's modification. Group shopping optimization module 110 may perform the recomputing in an interactive manner with the user.

In step 208, group shopping optimization module 110 outputs the optimized shopping order for each user. Group shopping optimization module 110 may recommend an optimized shopping order for each user in a group of shopping users. Group shopping optimization module 110 may automatically recommend for each user of the shopping group a shopping order that satisfies the user's preferences and constraints and at the same time optimize the objectives for each user. Group shopping optimization module 110 may automatically split goods between group members to optimize the objectives for each user.

In step 210, group shopping optimization module 110 learns additional preferences and constraints for each user from the optimized shopping orders over time. Group shopping optimization module 110 may learn users' preferences over time and may use the preferences in the future for recommending optimized shopping orders. In an example, group shopping optimization module 110 may analyze the history of shopping orders and preferences and constraints of a user. Group shopping optimization module 110 may update the preferences and constraints for the user. For example, group shopping optimization module 110 may extract the historical shopping orders of the user. For each item in the historical shopping orders, group shopping optimization module 110 may extract minimum and maximum quantities ordered and may add a quantity constraint between the minimum and maximum quantities. For each item in the historical shopping orders, group shopping optimization module 110 may extract the most common brand of the item and may add a preference, e.g., the most common brand, to the preferences of the user.

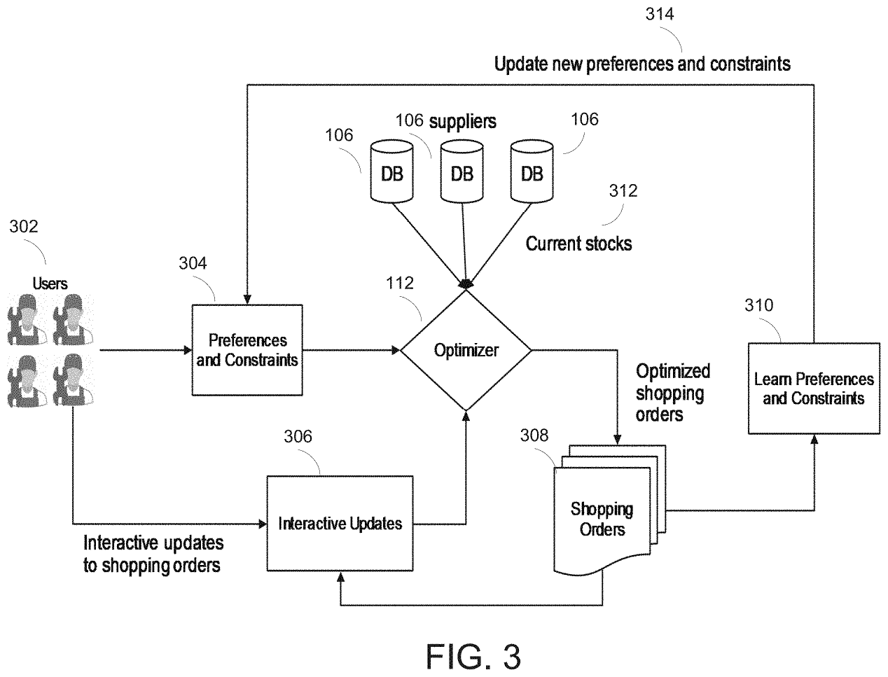

FIG. 3 illustrates an exemplary functional diagram of group shopping optimization module 110 in accordance with one or more embodiments of the present disclosure.

In the example of FIG. 3, group shopping optimization module 110 including optimizer 112 may generate shopping orders 308 for users 302, based on preferences and constraints 304 of users on items to buy from current stocks 312, e.g., based on supply database 106. Supply database 106 may store data and information of stocks 312 available for users 302 to buy. The group of shopping users 302 may want to buy various items or products in bulk. In an example, each user may have the user's own preferences and constraints 304 with respect to brands, quantity of products, and other aspects. Group shopping optimization module 110 through optimizer 112 may optimize shopping orders 308 for users 302 based on objectives of users 302. Group shopping optimization module 110 may return new optimized orders 308 for users. Group shopping optimization module 110 may interactively update shopping orders 308 based on interactive updates 306 from users 302. For example, group shopping optimization module 110 may provide user interface 114 for a user to select the shopping order and modify the shopping order, e.g., by adding or removing items, and or changing quantities of existing items. Group shopping optimization module 110 may take into consideration the modifications coming from users 302 and may recompute and generate optimized shopping orders 308 for users 302 based on the user's modifications. Group shopping optimization module 110 may perform the recomputing in an interactive manner with users 302. Group shopping optimization module 110 may learns additional preferences and constraints 310 for users from optimized shopping orders 308 over time. Group shopping optimization module 110 may learn users' preferences over time and may update new preferences and constraints 314 in the future for recommending shopping orders.

FIG. 4 depicts a block diagram 400 of components of computing device 102 in accordance with an illustrative embodiment of the present disclosure. It should be appreciated that FIG. 4 provides only an illustration of one implementation and does not imply any limitations with regard to the environments in which different embodiments may be implemented. Many modifications to the depicted environment may be made.

Computing device 102 may include communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Group shopping optimization module 110 may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Group shopping optimization module 110 may be downloaded to persistent storage 408 through communications unit 410.

I/O interface(s) 412 allows for input and output of data with other devices that may be connected to computing device 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., group shopping optimization module 110 can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A computer-implemented method comprising:
generating an initial shopping order for each user in a group of shopping users, based on one or more preferences and constraints of each user in the group of shopping users on one or more items to buy from a stock;
optimizing the initial shopping order for each user in the group of shopping users based on one or more objectives of each user in the group of shopping users;
interactively updating the optimized shopping order based on an interactive input from each user in the group of shopping users with a user interface, wherein the optimizing the initial shopping order for each user in the group of shopping users comprises dynamically updating the stock to reflect a change to the initial shopping order of each user in the group of shopping users;
randomly and intermittently adjusting a quantity of an item in the initial shopping order for each user in the group of shopping users;
satisfying the one or more preferences and constraints of each user in the group of shopping users;
intermittently updating the initial shopping order based on quantity adjustments that satisfy the one or more preferences and constraints as well as the one or more objectives of each user in the group of shopping users;
updating a stock value associated with the item based on the quantity adjustments of the item;
updating an objective function for each user in the group of shopping users based on the updated initial shopping order;
outputting the optimized shopping order for each user in the group of shopping users; and
learning additional preferences and constraints for each user in the group of shopping users from the optimized shopping order for each user in the group of shopping users, wherein learning additional preferences and constraints comprises:
extracting historical shopping orders of each user;
analyzing the historical shopping orders and preferences and constraints of each user;
updating the preferences and constraints for each user;
extracting minimum and maximum quantities ordered;
adding a quantity constraint between the minimum and maximum quantities;
extracting a most common brand of the item; and
adding a preference to the preferences of each user.

2-4. (canceled)

5. The computer-implemented method of claim 1, wherein the optimizing the initial shopping order for each user in the group of shopping users comprises resolving a conflict of one or more objectives between multiple users in the group of shopping users.

6. (canceled)

7. The computer-implemented method of claim 1, wherein the one or more objectives are selected from the group consisting of: minimizing a cost, minimizing a waste, maximizing a number of items, and maximizing discounts.

8. A computer program product comprising:
one or more computer readable storage media, and program instructions collectively stored on the one or more computer readable storage media, the program instructions comprising:
program instructions to generate an initial shopping order for each user in a group of shopping users, based on one or more preferences and constraints of each user in the group of shopping users on one or more items to buy from a stock;
program instructions to optimize the initial shopping order for each user based on one or more objectives of each user in the group of shopping users;
program instructions to interactively update the optimized shopping order based on an interactive input from each user in the group of shopping users with a user interface, wherein program instructions to optimize the initial shopping order for each user in the group of shopping users comprise program instructions to dynamically update the stock to reflect a change to the initial shopping order of each user in the group of shopping users;
program instructions to randomly and intermittently adjust a quantity of an item in the initial shopping order for each user in the group of shopping users;
program instructions to satisfy the one or more preferences and constraints of each user in the group of shopping users;
program instructions to intermittently update the initial shopping order based on quantity adjustments that satisfy the one or more preferences and constraints as well as the one or more objectives of each user in the group of shopping users;
program instructions to update a stock value associated with the item based on the quantity adjustments of the item;
program instructions to update an objective function for each user in the group of shopping users based on the updated initial shopping order;
program instructions to output the optimized shopping order for each user in the group of shopping users; and
program instructions to learn additional preferences and constraints for each user in the group of shopping users from the optimized shopping order for each user in the group of shopping users, wherein program instructions to learn additional preferences and constraints comprise:
program instructions to extract historical shopping orders of each user;
program instructions to analyze the historical shopping orders and preferences and constraints of each user;
program instructions to update the preferences and constraints for each user;
program instructions to extract minimum and maximum quantities ordered;
program instructions to add a quantity constraint between the minimum and maximum quantities;
program instructions to extract a most common brand of the item; and
program instructions to add a preference to the preferences of each user.

9-11. (canceled)

12. The computer program product of claim 8, wherein the program instructions to optimize the initial shopping order for each user in the group of shopping users comprise program instructions to resolve a conflict of one or more objectives between multiple users in the group of shopping users.

13. (canceled)

14. The computer program product of claim 8, wherein the one or more objectives are selected from the group consisting of: minimizing a cost, minimizing a waste, maximizing a number of items, and maximizing discounts.

15. A computer system comprising:
one or more computer processors, one or more computer readable storage media, and program instructions stored on the one or more computer readable storage media for execution by at least one of the one or more computer processors, the program instructions comprising:
program instructions to generate an initial shopping order for each user in a group of shopping users, based on one or more preferences and constraints of each user in the group of shopping users on one or more items to buy from a stock;
program instructions to optimize the initial shopping order for each user based on one or more objectives of each user in the group of shopping users;
program instructions to interactively update the optimized shopping order based on an interactive input from each user in the group of shopping users with a user interface, wherein program instructions to optimize the initial shopping order for each user in the group of shopping users comprise program instructions to dynamically update the stock to reflect a change to the initial shopping order of each user in the group of shopping users;
program instructions to randomly and intermittently adjust a quantity of an item in the initial shopping order for each user in the group of shopping users;
program instructions to satisfy the one or more preferences and constraints of each user in the group of shopping users;
program instructions to intermittently update the initial shopping order based on quantity adjustments that satisfy the one or more preferences and constraints as well as the one or more objectives of each user in the group of shopping users;
program instructions to update a stock value associated with the item based on the quantity adjustments of the item;
program instructions to update an objective function for each user in the group of shopping users based on the updated initial shopping order;
program instructions to output the optimized shopping order for each user in the group of shopping users; and
program instructions to learn additional preferences and constraints for each user in the group of shopping users from the optimized shopping order for each user in the group of shopping users, wherein program instructions to learn additional preferences and constraints comprise:
program instructions to extract historical shopping orders of each user;
program instructions to analyze the historical shopping orders and preferences and constraints of each user;
program instructions to update the preferences and constraints for each user;
program instructions to extract minimum and maximum quantities ordered;
program instructions to add a quantity constraint between the minimum and maximum quantities;
program instructions to extract a most common brand of the item; and
program instructions to add a preference to the preferences of each user.

16-18. (canceled)

19. The computer system of claim 15, wherein the program instructions to optimize the initial shopping order for each user in the group of shopping users comprise program instructions to resolve a conflict of one or more objectives between multiple users in the group of shopping users.

20. (canceled)
